(19) United States
(12) Patent Application Publication
(10) Pub. No.: US 2013/0338290 A1
(43) Pub. Date: Dec. 19, 2013

(54) FLAME-RETARDANT POLYAMIDES WITH POLYACRYLONITRILES

(71) Applicant: BASF SE, Ludwigshafen (DE)

(72) Inventors: Roland Helmut Krämer, Mannheim (DE); Alexander König, Bruchsal (DE); Peter Deglmann, Mannheim (DE); Axel Ebenau, Schifferstadt (DE); Michael Roth, Lautertal (DE); Klaus Uske, Bad Durkheim (DE); Martin Klatt, Mannheim (DE)

(21) Appl. No.: 13/912,432

(22) Filed: Jun. 7, 2013

Related U.S. Application Data
(60) Provisional application No. 61/660,846, filed on Jun. 18, 2012.

(51) Int. Cl. C08L 77/00

(52) U.S. Cl. CPC C08L 77/00
USPC 524/414

(57) ABSTRACT

The invention relates to thermoplastic molding compositions comprising
A) from 10 to 97% by weight of a thermoplastic polyamide,
B) from 0.1 to 60% by weight of red phosphorus,
C) from 1 to 25% by weight of a polyacrylonitrile homopolymer,
D) from 0 to 40% by weight of an impact modifier,
E) from 0 to 40% by weight of magnesium hydroxide, and
F) from 0 to 60% by weight of further additives,
   where the total of the percentages by weight of A) to F) is 100%.

The invention relates to thermoplastic molding compositions comprising
A) from 10 to 97% by weight of a thermoplastic polyamide,
B) from 0.1 to 60% by weight of red phosphorus,
C) from 1 to 25% by weight of a polyacrylonitrile homopolymer,
D) from 0 to 40% by weight of an impact modifier,
E) from 0 to 40% by weight of magnesium hydroxide, and
F) from 0 to 60% by weight of further additives,
   where the total of the percentages by weight of A) to F) is 100%.

The present invention further relates to the use of molding compositions of this type for producing fibers, foils, and moldings, and to the resultant moldings, fibers, and foils of any type.

It is known that addition of red phosphorus to thermoplastics, especially to reinforced or filled polyamides, leads to effective fire protection (DE-A-1931387). However, when red phosphorus is exposed to disadvantageous conditions, e.g. elevated temperature, moisture, or presence of alkali or oxygen, it tends to form decomposition products, such as phosphine and acids of mono- to pentavalent phosphorus.

A stabilizing effect can be achieved by adding oxides or hydroxides of zinc, of magnesium, or of copper. In DE-A-2625691, in addition to this stabilization by metal oxides, the phosphorus particles are coated with a polymer. However, said coating or encapsulation process is very complicated, and the stabilizing effect of the system is moreover not always satisfactory.

DE-A 2624065 discloses the flame-retardant effect of magnesium hydroxide, which is based on endothermic elimination of water and on the self-extinguishing effect of the resultant water vapor.

JP-A-2005/126633 discloses polyolefins which comprise polyacrylonitrile in combination with red phosphorus and metal hydroxide.

Properties that require improvement in the known molding compositions are smoke density and heat release rate. An increased amount of residue after combustion is also desirable, because the carbon layer formed delays development of a fire, and total heat release and total smoke generation are reduced.

It was therefore an object of the present invention to develop PA molding compositions which comprise red phosphorus as flame retardant and which exhibit reduced smoke density and heat release rate, and an increased amount of residue after combustion.

Accordingly, the molding compositions defined in the introduction have been found. Preferred embodiments can be found in the dependent claims.

Surprisingly, it has been found that thermoplastic molding compositions which comprise even small amounts of polyacrylonitrile comply in an excellent manner with the properties required.

The molding compositions of the invention comprise, as component A), from 10 to 97% by weight, preferably from 20 to 95% by weight, and in particular from 20 to 80% by weight, of at least one polyamide.

The polyamides of the molding compositions of the invention generally have an intrinsic viscosity of from 90 to 350 ml/g, preferably from 110 to 240 ml/g, determined in a 0.5% strength by weight solution in 96% strength by weight sulfuric acid at 25° C. to ISO 307.

Preference is given to semicrystalline or amorphous resins with a molecular weight (weight average) of at least 5000, described by way of example in the following U.S. Pat. Nos. 2,071,250, 2,071,251, 2,130,523, 2,130,948, 2,241,322, 2,312,966, 2,512,606, and 3,393,210.

Examples of these are polyamides that derive from lactams having from 7 to 13 ring members, e.g. polycaprolactam, polycapryllactam, and polylaurolactam, and also polyamides obtained via reaction of dicarboxylic acids with diamines.

Dicarboxylic acids which may be used are alkanedicarboxylic acids having from 6 to 12, in particular from 6 to 10, carbon atoms, and aromatic dicarboxylic acids. Merely as examples, acids that may be mentioned here are adipic acid, azelaic acid, sebacic acid, dodecanedioic acid and terephthalic and/or isophthalic acid.

Particularly suitable diamines are alkanediamines having from 6 to 12, in particular from 6 to 8, carbon atoms, and also m-xylylenediamine (e.g. Ultramid® X17 from BASF SE, where the molar ratio of MXDA to adipic acid is 1:1), di(4-aminophenyl)methane, di(4-aminocyclohexyl)-methane, 2,2-di(4-aminophenyl)propane, 2,2-di(4-aminocyclohexyl)propane, and 1,5-diamino-2-methylpentane.

Preferred polyamides are polyhexamethyleneadipamide, polyhexamethylenesebacamide, and polycaprolactam, and also nylon-6/6,6 copolyamides, in particular having a proportion of from 5 to 95% by weight of caprolactam units (e.g. Ultramid® C31 from BASF SE). Other suitable polyamides are obtainable from ω-aminoalkylnitriles, e.g. aminocapronitrile (PA 6) and adiponitrile, with hexamethylenediamine (PA 66) via what is known as direct polymerization in the presence of water, for example as described in DE-A 10313681, EP-A 1198491 and EP 922065.

Mention may also be made of polyamides obtainable, by way of example, via condensation of 1,4-diaminobutane with adipic acid at an elevated temperature (nylon-4,6). Preparation processes for polyamides of this structure are described by way of example in EP-A 38 094, EP-A 38 582, and EP-A 39 524.

Other suitable examples are polyamides obtainable via copolymerization of two or more of the abovementioned monomers, and mixtures of two or more polyamides in any desired mixing ratio. Particular preference is given to mixtures of nylon-6,6 with other polyamides, in particular nylon-6/6,6 copolyamides.

Other copolyamides which have proven particularly advantageous are semiaromatic copolyamides, such as PA 6/6T and PA 66/6T, where the triamine content of these is less than 0.5% by weight, preferably less than 0.3% by weight (see EP-A 299 444). Other polyamides resistant to high temperatures are known from EP-A 19 94 075 (PA 6T/6I/MXD6).

The processes described in EP-A 129 195 and 129 196 can be used to prepare the preferred semiaromatic copolyamides with low triamine content.

The following list, which is not comprehensive, comprises the polyamides A) mentioned and other polyamides A) for the purposes of the invention, and the monomers comprised:

AB polymers:
PA 4 Pyrrolidone
PA 6 ε-Caprolactam
PA 7 Ethanolactam
PA 8 Capryllactam
PA 9 9-Aminopelargonic acid
PA 11 11-Aminoundecanoic acid
PA 12 Laurolactam

AA/BB polymers:
PA 46 Tetramethylenediamine, adipic acid
PA 66 Hexamethylenediamine, adipic acid
PA 69 Hexamethylenediamine, azelaic acid
PA 610 Hexamethylenediamine, sebacic acid
PA 612 Hexamethylenediamine, decanedicarboxylic acid
PA 613 Hexamethylenediamine, undecanedicarboxylic acid
PA 1212 1,12-Dodecanediamine, decanedicarboxylic acid
PA 1313 1,13-Diaminotridecane, undecanedicarboxylic acid
PA 6T Hexamethylenediamine, terephthalic acid
PA 9T 1,9-Nonanediamine, terephthalic acid
PA MXD6 m-Xylylenediamine, adipic acid
PA 6I Hexamethylenediamine, isophthalic acid
PA 6-3-T Trimethylhexamethylenediamine, terephthalic acid
PA 6/6T (see PA 6 and PA 6T)
PA 6/66 (see PA 6 and PA 66)
PA 6/12 (see PA 6 and PA 12)
PA 66/6/610 (see PA 66, PA 6 and PA 610)
PA 6I/6T (see PA 6I and PA 6T)
PA PACM 12 Diaminodicyclohexylmethane, laurolactam
PA 6I/6T/PACM as PA 6I/6T+diaminodicyclohexylmethane
PA 12/MACMI Laurolactam, dimethyldiaminodicyclohexylmethane, isophthalic acid
PA 12/MACMT Laurolactam, dimethyldiaminodicyclohexylmethane, terephthalic acid
PA PDA-T Phenylenediamine, terephthalic acid

Preferred flame retardant B) is elemental red phosphorus, in particular in combination with glassfiber-reinforced molding compositions; this phosphorus can be used in untreated form.

However, particularly suitable preparations are those in which the phosphorus has been surface-treated with low-molecular-weight liquid substances, such as silicone oil, paraffin oil, or esters of phthalic acid (in particular dioctyl phthalate, see EP 176 836) or adipic acid, or with polymeric or oligomeric compounds, e.g. with phenolic resins or amino plastics, or else polyurethanes (see EP-A 384 232, DE-A 196 48 503). The amounts comprised of these materials known as phlegmatizers are generally from 0.05 to 5% by weight, based on 100% by weight of B).

Concentrates of red phosphorus, e.g. in a polyamide or elastomer, are also suitable as flame retardant. Particularly suitable concentrate polymers are polyolefin homo- and copolymers. However, the proportion of the concentrate polymer in the molding compositions of the invention, based on the weight of components A) and B), should not be more than 35% by weight—unless polyamide is used as thermoplastic.

Preferred concentrate constitutions are
B₁) from 30 to 90% by weight, preferably from 45 to 70% by weight, of a polyamide or elastomer,
B₂) from 10 to 70% by weight, preferably from 30 to 55% by weight, of red phosphorus.

The polyamide used for the masterbatch can differ from A) or preferably can be the same as A), so that no adverse effect on the molding composition arises from incompatibility phenomena or melting point differences.

The average particle size (d₅₀) of the phosphorus particles dispersed in the molding compositions is preferably in the range from 0.0001 to 0.5 mm; in particular from 0.001 to 0.2 mm.

The content of component B) in the molding compositions of the invention is from 0.1 to 60% by weight, preferably from 0.5 to 40% by weight, and in particular from 1 to 15% by weight, based on the entirety of components A) to E).

The molding compositions of the invention comprise, as component C), from 1 to 25% by weight, preferably from 1 to 15% by weight, and in particular from 1 to 11% by weight, of a polyacrylonitrile homopolymer. This is the term for polymers of the structure

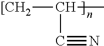

Polymers of this type can be produced via free-radical polymerization of acrylonitrile, where the polymerization process that is conventional in industry generally takes place in water, with initiators.

The average molecular weight M_{w} of preferred polyacrylonitriles is from 10 000 to 400 000, in particular from 50 000 to 350 000, measured by a method based on DIN 55672-2:2008-06 using GPC, part 2, with PMMA as eluent (standard).

With particular preference, polyacrylonitriles are mixed and compounded in the form of powder, pellets, chips, or tablets with the remaining components of the molding composition.

The molding compositions comprise, as component D), amounts of from 0 to 40% by weight, preferably from 1 to 30% by weight, in particular from 2 to 20% by weight, of elastomeric polymers (often also termed impact modifiers, elastomers, or rubbers).

These are very generally copolymers preferably composed of at least two of the following monomers: ethylene, propylene, butadiene, isobutene, isoprene, chloroprene, vinyl acetate, styrene, acrylonitrile, and acrylic or methacrylic esters having from 1 to 18 carbon atoms in the alcohol component.

Polymers of this type are described, for example, in Houben-Weyl, Methoden der organischen Chemie, Vol. 14/1 (Georg-Thieme-Verlag, Stuttgart, Germany, 1961), pages 392-406, and in the monograph by C. B. Bucknall, “Toughened Plastics” (Applied Science Publishers, London, UK, 1977).

Some preferred types of these elastomers are described below.

Preferred types of these elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0^{2,6}]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM rubbers and EPDM rubbers may preferably also have been grafted with reactive carboxylic acids or with derivatives of these. Examples of these are acrylic acid, methacrylic acid and derivatives thereof, e.g. glycidyl(meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These monomers comprising dicarboxylic acid derivatives and/or comprising epoxy groups are preferably incorporated into the rubber by adding to the monomer mixture monomers comprising dicarboxylic acid groups and/or epoxy groups and having the general formulae I or II or III or IV

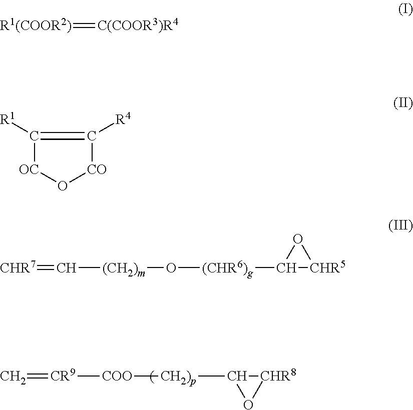

where R¹ to R⁹ are hydrogen or alkyl groups having from 1 to 6 carbon atoms, and m is a whole number from 0 to 20, g is a whole number from 0 to 10 and p is a whole number from 0 to 5.

The radicals R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising acid anhydride groups, the remaining amount being (meth)acrylates.

Particular preference is given to copolymers composed of
from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 5 to 40% by weight, of n-butyl acrylate and/or 2-ethylhexyl acrylate.

Other preferred (meth)acrylates are the methyl, ethyl, propyl, isobutyl and tert-butyl esters.

Comonomers which may be used alongside these are vinyl esters and vinyl ethers.

The ethylene copolymers described above may be prepared by processes known per se, preferably by random copolymerization at high pressure and elevated temperature. Appropriate processes are well-known.

Other preferred elastomers are emulsion polymers whose preparation is described, for example, by Blackley in the monograph “Emulsion Polymerization”. The emulsifiers and catalysts which can be used are known per se.

In principle it is possible to use homogeneously structured elastomers or else those with a shell structure. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as n-butyl acrylate and 2-ethylhexyl acrylate, corresponding methacrylates, butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, a-methylstyrene, p-methylstyrene, acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

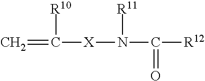

where the substituents can be defined as follows:
R¹⁰ is hydrogen or a C₁-C₄-alkyl group,
R¹¹ is hydrogen, a C₁-C₈-alkyl group or an aryl group, in particular phenyl,
R¹² is hydrogen, a C₁-C₁₀-alkyl group, a C₆-C₁₂-aryl group, or —OR¹³,
R¹³ is a C₁-C₈-alkyl group or a C₆-C₁₂-aryl group, which can optionally have substitution by groups that comprise O or by groups that comprise N,
X is a chemical bond, a C₁-C₁₀-alkylene group, or a C₆-C₁₂-arylene group, or

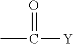

Y is O—Z or NH—Z, and
Z is a C₁-C₁₀-alkylene or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, n-butyl | styrene, acrylonitrile, methyl |
| | acrylate, ethylhexyl acrylate, | methacrylate |
| | or a mixture of these | |
| II | as I, but with concomitant use of | as I |
| | crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant |
| | | use of monomers having reactive |
| | | groups, as described herein |
| V | styrene, acrylonitrile, methyl | first envelope composed of |
| | methacrylate, or a mixture of | monomers as described under I |
| | these | and II for the core, second |
| | | envelope as described under I or |
| | | IV for the envelope |

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate-glycidyl acrylate or n-butyl acrylate-glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

Particularly preferred rubbers D) are ethylene copolymers, as described above, which comprise functional monomers, where the functional monomers have been selected from the group of the carboxylic acid groups, carboxylic anhydride groups, carboxylic ester groups, carboxamide groups, carboximide groups, amino groups, hydroxy groups, epoxy groups, urethane groups, and oxazoline groups, and mixtures of these.

The proportion of the functional groups is from 0.1 to 20% by weight, preferably from 0.2 to 10% by weight, and in particular from 0.3 to 7% by weight, based on 100% by weight of D).

Particularly preferred monomers are composed of an ethylenically unsaturated mono- or dicarboxylic acid or of a functional derivative of such an acid.

Compounds suitable in principle are any of the primary, secondary, and tertiary C₁-C₁₈-alkyl esters of acrylic acid or methacrylic acid, but preference is given to esters having from 1 to 12 carbon atoms, in particular having from 2 to 10 carbon atoms.

Examples of these are methyl, ethyl, propyl, n-butyl, isobutyl, and tert-butyl, 2-ethylhexyl, octyl, and decyl acrylates and the corresponding esters of methacrylic acid. Among these, particular preference is given to n-butyl acrylate and 2-ethylhexyl acrylate.

The olefin polymers can also comprise, instead of the esters or in addition to these, acid-functional and/or latently acid-functional monomers of ethylenically unsaturated mono- or dicarboxylic acids, or monomers having epoxy groups.

Further examples that may be mentioned of monomers are acrylic acid, methacrylic acid, tertiary alkyl esters of these acids, in particular tert-butyl acrylate, and dicarboxylic acids, such as maleic acid and fumaric acid, and derivatives of these acids, and also monoesters thereof.

Latently acid-functional monomers are compounds which form free acid groups under the polymerization conditions or during incorporation of the olefin polymers into the molding compositions. Examples of these that may be mentioned are anhydrides of dicarboxylic acids having up to 20 carbon atoms, in particular maleic anhydride, and tertiary C₁-C₁₂-alkyl esters of the abovementioned acids, in particular tert-butyl acrylate and tert-butyl methacrylate.

The acid-functional or latently acid-functional monomers and the monomers comprising epoxy groups are preferably incorporated into the olefin polymers via addition of compounds of the general formulae I-IV to the monomer mixture.

The melt index of the ethylene copolymers is generally in the range from 1 to 80 g/10 min (measured at 190° C. with 2.16 kg load).

The molar mass of these ethylene-a-olefin copolymers is from 10 000 to 500 000 g/mol, preferably from 15 000 to 400 000 g/mol (Mn, determined by means of GPC in 1,2,4-trichlorobenzene with PS calibration).

In one particular embodiment, ethylene-a-olefin copolymers produced by means of what are known as “single site catalysts” are used. Further details can be found in U.S. Pat. No. 5,272,236. The molecular weight polydispersity of the ethylene-α-olefin copolymers here is narrow for polyolefins: smaller than 4, preferably smaller than 3.5.

Commercially available products B used with preference are Exxelor® VA 1801 and 1803, Kraton® G 1901 FX and Fusabond® N NM493 D and Fusabond® A560 from Exxon, Kraton, and DuPont, and also Tafmer® MH 7010 from Mitsui.

It is also possible, of course, to use mixtures of the types of rubber listed above.

The molding compositions of the invention can comprise, as component E), from 0 to 40% by weight, preferably from 1 to 25% by weight, and in particular from 5 to 15% by weight, of Mg(OH)₂.

The products available commercially are lamellar solids. The specific BET surface area of preferred components E) in accordance with ISO 9277 is from 1 to 100 m²/g, in particular from 1 to 20 m²/g.

The average particle size from laser scattering is preferably from 0.1 to 20 μm, more preferably from 0.1 to 10 μm, and in particular from 0.1 to 5 μm. Production processes are known to the person skilled in the art, and further information would therefore be superfluous. Preference is given, as flame retardants in the molding compositions of the invention, to magnesium hydroxides which have a silane compound on the surface, as described below for the fillers F).

The molding compositions of the invention can comprise, as component F), up to 60% by weight, preferably up to 50% by weight, of further additives.

Fibrous or particulate fillers F) that may be mentioned are carbon fibers, glass fibers, glass beads, amorphous silica, calcium silicate, calcium metasilicate, magnesium carbonate, kaolin, chalk, powdered quartz, mica, barium sulfate, and feldspar, and the amounts that can be used of these are from 1 to 50% by weight, in particular from 5 to 40% by weight, preferably from 10 to 40% by weight.

Preferred fibrous fillers that may be mentioned are carbon fibers, aramid fibers, and potassium titanate fibers, particular preference being given to glass fibers in the form of E glass. These can be used as rovings or in the commercially available forms of chopped glass.

The fibrous fillers may have been surface-pretreated with a silane compound to improve compatibility with the thermoplastics.

Suitable silane compounds have the general formula:

(X—(CH₂)ₙ)ₖ—Si—(O—CₘH₂ₘ₊₁)₄₋ₖ

where the definitions of the substituents are as follows:

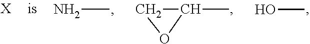

n is a whole number from 2 to 10, preferably 3 to 4,
m is a whole number from 1 to 5, preferably 1 to 2, and
k is a whole number from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface-coating are from 0.01 to 2% by weight, preferably from 0.025 to 1.0% by weight and in particular from 0.05 to 0.5% by weight (based on F)).

Acicular mineral fillers are also suitable.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may optionally have been pretreated with the abovementioned silane compounds, but the pretreatment is not essential.

Other fillers which may be mentioned are kaolin, calcined kaolin, wollastonite, talc and chalk, and also lamellar or acicular nanofillers, the amounts of these preferably being from 0.1 to 10%. Materials preferred for this purpose are boehmite, bentonite, montmorillonite, vermiculite, hectorite, and laponite. The lamellar nanofillers are organically modified by prior-art methods, to give them good compatibility with the organic binder. Addition of the lamellar or acicular nanofillers to the inventive nanocomposites gives a further increase in mechanical strength.

The molding compositions of the invention can comprise, as component F), from 0.05 to 3% by weight, preferably from 0.1 to 1.5% by weight, and in particular from 0.1 to 1% by weight, of a lubricant.

Preference is given to the salts of Al, of alkali metals, or of alkaline earth metals, or esters or amides of fatty acids having from 10 to 44 carbon atoms, preferably having from 12 to 44 carbon atoms.

The metal ions are preferably alkaline earth metal and Al, particular preference being given to Ca or Mg.

Preferred metal salts are Ca stearate and Ca montanate, and also Al stearate.

It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The molding compositions of the invention can comprise, as component F), from 0.05 to 3% by weight, preferably from 0.1 to 1.5% by weight, and in particular from 0.1 to 1% by weight, of a Cu stabilizer, preferably a Cu(I) halide, in particular in a mixture with an alkali metal halide, preferably KI, in particular in the ratio 1:4, or of a sterically hindered phenol, or a mixture of these.

Preferred salts of monovalent copper used are copper(I) acetate, copper(I) chloride, copper(I) bromide, and copper(I) iodide. The material can also comprise phosphine complexes (specifically bistriphenylphosphinecopper iodide). The amounts comprised of these are from 5 to 500 ppm of copper, preferably from 10 to 250 ppm, based on polyamide.

The advantageous properties are in particular obtained when the copper is present with molecular dispersion in the polyamide. This is achieved if a concentrate added to the molding composition comprises the polyamide, a salt of monovalent copper, and an alkali metal halide in the form of a solid, homogeneous solution. A typical concentrate is composed by way of example of from 79 to 95% by weight of polyamide and from 21 to 5% by weight of a mixture of copper iodide or copper bromide and potassium iodide. The copper concentration of the solid homogeneous solution is preferably from 0.3 to 3% by weight, in particular from 0.5 to 2% by weight, based on the total weight of the solution, and the molar ratio of copper(I) iodide to potassium iodide is from 1 to 11.5, preferably from 1 to 5.

Suitable polyamides for the concentrate are homopolyamides and copolyamides, in particular nylon-6 and nylon-6,6.

Suitable sterically hindered phenols F) are in principle all of the compounds which have a phenolic structure and which have at least one bulky group on the phenolic ring.

Examples of compounds that can be used are those of the formula

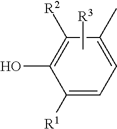

where:

R¹ and R² are an alkyl group, a substituted alkyl group, or a substituted triazole group, and where the radicals R¹ and R² may be identical or different, and R³ is an alkyl group, a substituted alkyl group, an alkoxy group, or a substituted amino group.

Antioxidants of the abovementioned type are described by way of example in DE-A 27 02 661 (U.S. Pat. No. 4,360,617).

Another group of preferred sterically hindered phenols is derived from substituted benzenecarboxylic acids, in particular from substituted benzenepropionic acids.

Particularly preferred compounds from this class are compounds of the formula

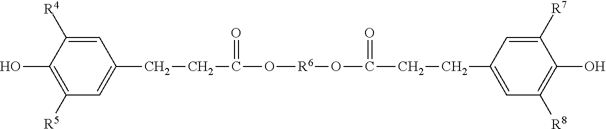

where R⁴, R⁵, R⁷, and R⁸, independently of one another, are C₁-C₈-alkyl groups which themselves may have substitution (at least one of these being a bulky group), and R⁶ is a divalent aliphatic radical which has from 1 to 10 carbon atoms and whose main chain may also have C—O bonds.

Preferred compounds corresponding to this formula are

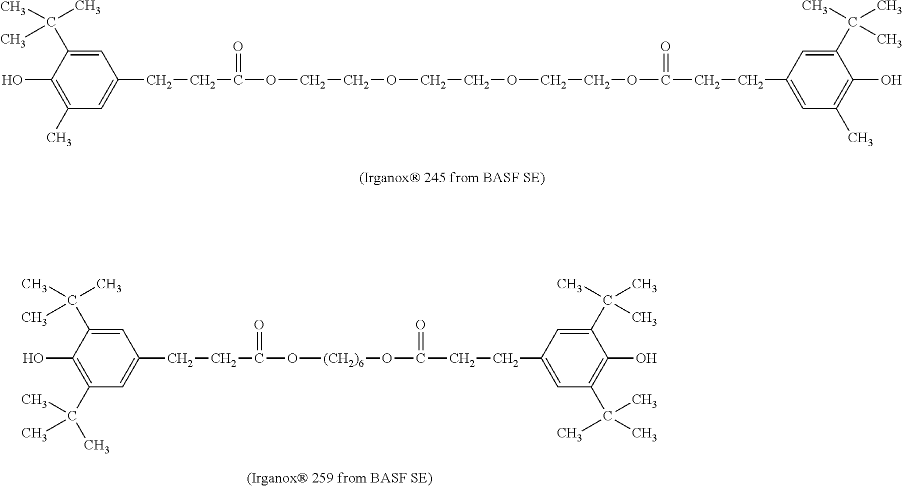

All of the following may be mentioned as examples of sterically hindered phenols:

2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxyphenyl)-propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl)propionate (Irganox® 259), pentaerythrityl tetrakis[3-(3,5-di-tert-butyl-4-hydroxyphenyl)propionate], and also N,N′-hexamethylenebis-3,5-di-tert-butyl-4-hydroxyhydro-cinnamide (Irganox® 1098), and the product Irganox® 245 described above from BASF SE, which has particularly good suitability.

The amount present of the antioxidants F), which can be used individually or in the form of a mixture, is from 0.05 up to 3% by weight, preferably from 0.1 to 1.5% by weight, in particular from 0.1 to 1% by weight, based on the total weight of the molding compositions A) to F).

In some instances, sterically hindered phenols having not more than one sterically hindered group in ortho-position with respect to the phenolic hydroxy group have proven particularly advantageous, in particular when assessing colorfastness on storage in diffuse light over prolonged periods.

The molding compositions of the invention can comprise, as component F), from 0.05 to 5% by weight, preferably from 0.1 to 2% by weight, and in particular from 0.25 to 1.5% by weight, of a nigrosin.

Nigrosins are generally a group of black or gray phenazine dyes (azine dyes) related to the indulines and taking various forms (water-soluble, oil-soluble, spirit-soluble), used in wool dyeing and wool printing, in black dyeing of silks, and in the coloring of leather, of shoe creams, of varnishes, of plastics, of stoving lacquers, of inks, and the like, and also as microscopy stains.

Nigrosins are obtained industrially via heating of nitrobenzene, aniline, and aniline hydrochloride with metallic iron and FeCl₃ (the name being derived from the Latin niger=black).

Component F) can be used in the form of free base or else in the form of salt (e.g. hydrochloride).

Further details concerning nigrosins can be found by way of example in the electronic encyclopedia Römpp Online, Version 2.8, Thieme-Verlag Stuttgart, 2006, keyword “Nigrosin”.

The thermoplastic molding compositions of the invention can comprise, as component F), conventional processing aids, such as stabilizers (e.g. ZnO for red phosphorus), oxidation retarders, agents to counteract decomposition by heat and decomposition by ultraviolet light, lubricants and mold-release agents, colorants, such as dyes and pigments, nucleating agents, plasticizers, etc.

Examples of oxidation retarders and heat stabilizers are sterically hindered phenols and/or phosphites and amines (e.g. TAD), hydroquinones, aromatic secondary amines, such as diphenylamines, various substituted members of these groups, and mixtures of these, in concentrations of up to 1% by weight, based on the weight of the thermoplastic molding compositions.

UV stabilizers that may be mentioned, the amounts of which used are generally up to 2% by weight, based on the molding composition, are various substituted resorcinols, salicylates, benzotriazoles, and benzophenones.

Materials that can be added as colorants are inorganic pigments, such as titanium dioxide, ultramarine blue, iron oxide, and carbon black, and also organic pigments, such as phthalocyanines, quinacridones, perylenes, and also dyes, such as anthraquinones.

Materials that can be used as nucleating agents are sodium phenylphosphinate, aluminum oxide, silicon dioxide, and also preferably talc.

The thermoplastic molding compositions of the invention can be produced by processes known per se, by mixing the starting components in conventional mixing apparatuses, such as screw-based extruders, Brabender mixers, or Banbury mixers, and then extruding same. The extrudate can be cooled and pelletized. It is also possible to premix individual components and then to add the remaining starting materials individually and/or likewise in the form of a mixture. The mixing temperatures are generally from 230 to 320° C.

In another preferred mode of operation, components B) and C), and also optionally D), E and F), can be mixed with a prepolymer, compounded, and pelletized. The resultant pellets are then solid-phase-condensed under inert gas continuously or batchwise at a temperature below the melting point of component A) until the desired viscosity has been reached.

The thermoplastic molding compositions of the invention feature good flame retardancy with relatively low phosphorus content. There is a reduction in smoke density and heat release rate, and there is an increased amount of residue after combustion. These materials are therefore suitable for producing fibers, foils, and moldings of any type. Some examples are mentioned as follows: plug connectors, plugs, plug parts, cable harness components, circuit mounts, circuit mount components, three-dimensionally injection-molded circuit mounts, electrical connection elements, and mechatronic components.

The moldings or semifinished products to be produced in accordance with the invention from the thermoplastic molding compositions can by way of example be used in the motor vehicle industry, electrical industry, electronics industry, telecommunications industry, information technology industry, consumer electronics industry, or computer industry, or in vehicles and other means of conveyance, in ships, in spacecraft, in the domestic sector, in office equipment, in sports, in medicine, and also generally in articles and buildings components which require increased fire protection.

In the kitchen and domestic sector, improved-flow polyamides can be used to produce components for kitchen equipment, e.g. fryers, smoothing irons, and buttons, and also for applications in the garden and leisure sector.

### EXAMPLES

The following components were used:

Component A:

Nylon-6 with intrinsic viscosity IV of 124 ml/g, measured in 0.5% by weight solution in 96% by weight sulfuric acid at 25° C. in accordance with ISO 307 (Ultramid® B24 from BASF SE was used).

Component B:

50% concentrate made of red phosphorus with average particle size (d₅₀) of from 10 to 30 μm in nylon-6.

Component C1:

Polyacrylonitrile, M_{w}: 313 400 g/mol, DIN 55672-2:2008-06 using GPC, part 2, PMMA standard.

Component C2: (for comparison)

styrene-acrylonitrile copolymer

random copolymer composed of 24% of acrylonitrile and 76% of styrene

Component C3: (for comparison)

chopped polyacrylonitrile fiber

acrylonitrile-vinyl acetate copolymer:

acrylonitrile: 94%

vinyl acetate: 5%

other constituents: 1%

chopped length: 8 μm

Component D:

Olefin polymer made of: 59.8% by weight of ethylene, 35% by weight of n-butyl acrylate, 4.5% by weight of acrylic acid, and 0.7% by weight of maleic anhydride with melt index MFI (190/2.16) of 10 g/10 min. The copolymer was produced by copolymerizing the monomers at elevated temperature and elevated pressure.

Component E:
Mg(OH)₂ d₅₀: 1.4-2.0 μm (laser diffraction)
   BET surface area: from 4 to 6 m²/g (DIN ISO 9277)
   Purity: 99.8%

Component F/1:

Standard chopped glass fiber for polyamides, length=4.5 mm, diameter=10 μm.

Component F/2:

N,N′-Hexamethylenebis-3,5-di-tert-butyl-4-hydroxyhydrocinnamide (Irganox® 1098)

Component F/3:

Ca stearate

In order to demonstrate the phosphorus stability improvements described in the invention, appropriate plastics molding compositions were manufactured by compounding. For this purpose, the individual components were mixed in a ZSK 26 twin-screw extruder (Berstorff) at throughput 20 kg/h and with flat temperature profile at about 280° C., discharged in the form of strand, cooled until pelletizable, and pelletized.

The test specimens for the test listed in Table 1 were injection molded in an Arburg 420C injection molding machine at a melt temperature of about 270° C. and at a mold temperature of about 80° C.

Testing of Plastics Parts
1) Mechanic properties in accordance with ISO 527-2/1A/S and Charpy impact resistance, ISO 179-2/1eU
2) Fire test in accordance with UL 94; 0.8 mm specimen
3) Smoke density, heat release, and mass after combustion in accordance with ISO 5660-1:2002

The tables give the compositions and the molding compositions and the results of the tests.

TABLE 1

| Compositions | 1V | 2V | 3 | 4 | 5 | 6 | 7V | 8V | 9V | 10V | 11*V |
|---|---|---|---|---|---|---|---|---|---|---|---|
| [% by wt.] | [%] | [%] | [%] | [%] | [%] | [%] | [%] | [%] | [%] | [%] | [%] |
| A | 66.6 | 53.6 | 51.1 | 48.6 | 43.6 | 38.6 | 48.6 | 43.6 | 41.1 | 38.6 | 46.1 |
| B | | 13.0 | 13.0 | 13.0 | 13.0 | 13.0 | 13.0 | 13.0 | 13.0 | 13.0 | 13.0 |
| C1 | | | 2.5 | 5.0 | 10.0 | 5.0 | | | | | |
| C2 | | | | | | | 5.0 | 10.0 | 10.0 | 10.0 | |
| C3 | | | | | | | | | | | 5.0 |
| D | 6.0 | 6.0 | 6.0 | 6.0 | 6.0 | 6.0 | 6.0 | 6.0 | 6.0 | 6.0 | 6.0 |
| E | | | | | | 10.0 | | | 2.5 | 5.0 | 2.5 |
| F1 | 26.0 | 26.0 | 26.0 | 26.0 | 26.0 | 26.0 | 26.0 | 26.0 | 26.0 | 26.0 | 26.0 |
| F2 + F3 + F4 | 1.4 | 1.4 | 1.4 | 1.4 | 1.4 | 1.4 | 1.4 | 1.4 | 1.4 | 1.4 | 1.4 |
| (1:1:2) | | | | | | | | | | | |

*Material could not be processed, because of difficulties with metering and poor miscibility of component C3.

Tables 2-4

| Mechanic properties | Standard | 1V | 2V | 3 | 4 | 5 | 6 | 7V | 8V | 9V | 10V |
|---|---|---|---|---|---|---|---|---|---|---|---|
| Modulus of elasticity | ISO 527- | 7392 | 7892 | 7982 | 8043 | 8204 | 7857 | 7928 | 8164 | 8036 | 8031 |
| [MPa] | 2/1A/5 | | | | | | | | | | |
| Tensile stress at break | ISO 527- | 122 | 124 | 127 | 124 | 124 | 115 | 116 | 112 | 112 | 110 |
| (σ_B) [MPa] | 2/1A/5 | | | | | | | | | | |
| Tensile strain at break | ISO 527- | 3.4 | 3.0 | 2.9 | 2.6 | 2.5 | 2.7 | 3.12 | 2.67 | 2.71 | 2.70 |
| (□_B) [MPa] | 2/1A/5 | | | | | | | | | | |
| Unnotched Charpy, 23° C. | ISO 179- | 60.5 | 63.3 | 59.9 | 54.9 | 51.5 | 43.7 | 64.8 | 57.9 | 53.5 | 51.7 |
| [kJm * 2 * ] | 2/1eU | | | | | | | | | | |

| UL 94, 0.8 mm | 1V | 2V | 3 | 4 | 5 | 6 | 7V | 8V | 9V | 10V |
|---|---|---|---|---|---|---|---|---|---|---|
| Total combustion time | >90 | 73 | 32 | 49 | 41 | 30 | 115.6 | >90 | 88.5 | 86.5 |
| Ignition of cotton indicator | Ja | Nein | Nein | Nein | Nein | Nein | Ja | Ja | Ja | Nein |
| UL 94 classification | V- | V1 | V2 | V0 | V0 | V0 | V2 | V- | V2 | V1 |

| Cone calorimeter 50 kW m-2 | | 1V | 2V | 3 | 4 | 5 | 6 |
|---|---|---|---|---|---|---|---|
| Average heat release at 180 s after | ISO 5660-1:2002 | 222 | 160 | 138 | 135 | 122 | 112 |
| ignition | | | | | | | |
| Mass at end of test (%) | ISO 5660-1:2002 | 27 | 39 | 41 | 45 | 49 | 49 |
| Spec. extinction area [m2/kg] | ISO 5660-1:2002 | 213 | 585 | 469 | 508 | 474 | 410 |
| (smoke density) | | | | | | | |

1-9. (canceled)

10. A thermoplastic molding composition comprising
A) from 10 to 97% by weight of a thermoplastic polyamide,
B) from 0.1 to 60% by weight of red phosphorus,
C) from 1 to 25% by weight of a polyacrylonitrile homopolymer,
D) from 0 to 40% by weight of an impact modifier,
E) from 0 to 40% by weight of magnesium hydroxide, and
F) from 0 to 60% by weight of further additives,
where the total of the percentages by weight of A) to F) does not exceed 100%.

11. The thermoplastic molding composition according to claim 10, comprising
A) from 10 to 97% by weight,
B) from 0.5 to 40% by weight,
C) from 1 to 15% by weight,
D) from 0 to 40% by weight,
E) from 1 to 25% by weight and
F) from 0 to 50% by weight.

12. The thermoplastic molding composition according to claim 10, comprising
A) from 20 to 95% by weight,
B) from 0.5 to 40% by weight,
C) from 1 to 15% by weight,
D) from 1 to 30% by weight and
E) from 1 to 25% by weight.

13. The thermoplastic molding composition according to claim 10, in which the average molecular weight M_{w} of component C) is from 10,000 to 400,000 in accordance with DIN 55672-2:2008-06, part 2 (PMMA as standard).

14. The thermoplastic molding composition according to claim 12, in which the average molecular weight M_{w} of component C) is from 10,000 to 400,000 in accordance with DIN 55672-2:2008-06, part 2 (PMMA as standard).

15. The thermoplastic molding composition according to claim 10, in which component D) is composed of an ethylene copolymer which comprises from 0.1 to 20% by weight of functional monomers.

16. The thermoplastic molding composition according to claim 14, in which component D) is composed of an ethylene copolymer which comprises from 0.1 to 20% by weight of functional monomers.

17. The thermoplastic molding composition according to claim 10, in which the BET surface area of component E) is from 1 to 100 m²/g in accordance with DIN ISO 9277.

18. The thermoplastic molding composition according to claim 16, in which the BET surface area of component E) is from 1 to 100 m²/g in accordance with DIN ISO 9277.

19. The thermoplastic molding composition according to claim 10, in which component C) in the form of pellets, powder, chips, or tablets is mixed and compounded with the other components A) and B), and also optionally D, E, and F).

20. A process for producing fibers, foils, or moldings which comprise utilizing the thermoplastic molding compositions according to claim 10.

21. A fiber, foil or molding obtainable from the thermoplastic molding compositions according to claim 10.
